(19) United States
(12) Patent Application Publication
(10) Pub. No.: US 2007/0178432 A1
(43) Pub. Date: Aug. 2, 2007

(54) Test management and assessment system and method

(76) Inventors: Les Davis, Haverhill, MA (US); Andrey Lisichenok, Danvers, MA (US); Bethany Silver, Manchester, CT (US)

Correspondence Address: THOMPSON COBURN, LLP, ONE US BANK PLAZA, SUITE 3500, ST LOUIS, MO, 63101, US

(21) Appl. No.: 11/346,105

(22) Filed: Feb. 2, 2006

(51) Int. Cl. G09B 7/00

(52) U.S. Cl. 434/353

(57) ABSTRACT

A test management and assessment system allows the user to create a test and answer sheet. The system includes a device having a user interface defining a plurality of input fields from which the test is created. The input fields include a plurality of question fields in which a corresponding plurality of questions can be input, a corresponding plurality of answer key fields in which a plurality of correct answers for each of the plurality of questions can be input, and a corresponding plurality of question value fields in which a plurality of question values can be selectively assigned to each question. The answer sheet has a plurality of test data fields, including answer fields in which a test-taker can input answers. The system includes scanning means for scanning answer sheets upon their completion and assessment means for automatically grading the answer sheets as they are scanned.

### BACKGROUND OF THE INVENTION

The present invention is directed to a test management and assessment system and method and in particular, an improved system and method for managing the administration of tests and assessing test performance.

In January of 2002, President Bush signed into law the No Child Left Behind (NCLB) Act. The NCLB was enacted in order to improve the performance of America's elementary and secondary schools. The government earmarked four billion dollars in 2002 for this educational reform. Each state receives federal dollars for its public and charter schools based on the performance of those schools. One of the main mechanisms for assessing performance is through testing and test scores. As a result, schools have begun placing far more of an emphasis on preparing students for standardized tests.

As schools prepare their students for these mandated tests, they often conduct numerous practice tests. However, students and teachers need accurate and timely turnaround in order to effectively address deficiencies revealed by the practice exams. Hand grading tests leaves little time for review between tests. As a result, automated testing, often referred to as “bubble sheet testing,” is used by many schools to help address this concern. However, given that bubble test sheets can cost from 5 cents to 25 cents per sheet, this can become expensive. In addition, if the school hasn't purchased a scanner to grade bubble sheets, tests must be sent offsite to be graded, further increasing costs and preventing the timely review thereof. Teachers can wait weeks and even months to receive the results of practice tests, giving them little opportunity to address problem areas with students. Finally, when tests are graded manually, the results cannot be analyzed in the aggregate, students' performance cannot be accurately or effectively assessed, and trends or benchmarks cannot be detected. All of these deficiencies have a significant negative impact on the quality of education provided by a school.

The management of the information associated with such testing is also a constant struggle. First, the information often exists in both hard copy and digital form, and in the latter case, the often in different formats. Second, numerous communications mediums now exist to distribute the information (e.g., mail, email, fax, etc.). Third, delivery times often differ depending on the document being distributed and/or the recipients of the communication. Moreover, these parameters are constantly changing depending on the circumstances. Fourth, since forms often constitute a huge part of the testing environment, keeping them up to date is a big challenge, and keeping a supply of forms on hand can create logistical problem, simply because of the amount of space needed to store all of the forms that any given educational institution may use.

These problems exist not only for schools, but any organization or entity having an educational or training component. The present invention overcomes the foregoing limitations. In accordance with the present invention, the need for an improved system and method for efficiently and economically managing the administration of tests and assessing the results thereof can be fulfilled.

### SUMMARY OF THE INVENTION

In one aspect of the present invention a test management and assessment system is provided. The system uses an answer sheet having a plurality of test data fields. The answer sheet uses test data fields including answer fields in which a test taker can input answers. The system also comprising a device having a user interface defining a plurality of input fields and configured to receive input from a user from which a test for the answer sheet is created. The input fields preferably include a plurality of question fields in which a corresponding plurality of questions can be input, a corresponding plurality of answer key fields in which a plurality of correct answers for each of the plurality of questions can be input, and a corresponding plurality of question value fields in which a plurality of question values can be selectively assigned to each question. The system also includes scanning means for scanning answer sheets upon their completion; and assessment means accessible from the computer for automatically grading the answer sheets as they are scanned based on the correct answers and the question values. The system may also include comprising storage means for storing a test created via the user interface. The user interface may then be configured to allow a user to selectively edit the input associated with a stored test.

Preferably, the system input fields further comprise a plurality of content fields in which a plurality of types of content may be assigned to each question. In accordance with this aspect of the invention, the assessment means may comprise means for assessing the scanned answers for each answer sheet by content. The answer sheet test data fields may also include a test taker field in which the name of a test taker may be input. In accordance with this aspect of the invention, the assessment means comprises means for assessing the scanned answers by test taker. The answer sheet test data fields may also include a class name input field in which the name of the class for which the test is being administered may be input. In accordance with this aspect of the invention, the assessment means comprises means for assessing the scanned answers by class. The answer sheet test data fields may also include a teacher input field in which the name of the teacher for which the test is being administered may be input. In accordance with this aspect of the invention, the assessment means comprises means for assessing the scanned answers by teacher. In another aspect of the present invention, a unique, machine readable identifier may be assigned to the test. The unique identifier when scanned automatically populates at least a portion of the test data fields of the answer sheet. The unique identifier preferably identifies the test and reduces manual data input associated with the test during scanning.

Preferably, the assessment means further comprises means for creating a plurality of reports from which the test data can be assessed. Preferably, at least one of the plurality of created reports comprises statistics relating to a test-taker's individual performance on the assessment and statistics relating to an overall performance of all test-takers taking the assessment. The created report may also comprises a test-taker's responses to each question on the assessment. The created report may also comprises categories of questions based upon distinct subject matter areas and statistics relating to a test taker's individual performance on the distinct subject matter area questions.

In another aspect of the present invention, a method of test management and assessment is provided. In accordance with the method of the present invention, each test uses an answer sheet having a plurality of test data fields that include answer fields in which a test taker can input answers. Under the method, a user interface is provided. The user interface is configured to receive input from a user from which a test for the answer sheet may be created. The user interface also preferably defines a plurality of input fields that may include a plurality of question fields in which a corresponding plurality of questions can be input, a corresponding plurality of answer key fields in which a plurality of correct answers for each of the plurality of questions can be input, and a corresponding plurality of question value fields in which a plurality of question values can be selectively assigned to each question. The method further comprises scanning the answer sheets upon their completion; and automatically grading the answer sheets as they are scanned based on the correct answers and the question values.

In another aspect of the present invention, the method further comprises storing a test created via the user interface. In accordance with this aspect of the invention, the user interface is further configured to allow a user to selectively edit the input associated with a stored test. The method may also include providing input fields comprising a plurality of content fields in which a plurality of types of content may be assigned to each question. In accordance with this aspect of the invention, the method further comprises the step of assessing the scanned answers for each answer sheet by content. The method may also include providing test data fields comprising a test taker field in which the name of a test taker may be input. In accordance with this aspect of the invention, the method further comprises the step of assessing the scanned answers by test taker. The method may also include providing test data fields comprising a class name input field in which the name of the class for which the test is being administered may be input. In accordance with this aspect of the invention, the method further comprises assessing the scanned answers by class. The method may also include providing test data fields comprising a teacher input field in which the name of the teacher for which the test is being administered may be input. In accordance with this aspect of the invention, the method further comprises the step of assessing the scanned answers by teacher.

In another aspect of the method of present invention, a plurality of reports may be created from which the test data can be assessed. In accordance with this aspect of the invention, the method further comprises displaying on at least one of the plurality of created reports statistics relating to a test-taker's individual performance on the assessment and statistics relating to an overall performance of all test-takers taking the assessment. The method may also include displaying a test-taker's responses to each question on the assessment. The method may also include categorizing questions on the assessment into distinct subject matter areas, and displaying statistics relating to a test taker's individual performance on the distinct subject matter area questions.

Further objects and features of the invention are revealed in the following detailed description of the preferred embodiment of the invention and in the drawings which follow.

### BRIEF DESCRIPTION OF THE DRAWINGS

FIG. 1 is a block diagram of a test management and assessment system in accordance with one embodiment of the present invention.

FIG. 2 is an embodiment of a screen display and a New Assessment window generated by the test management and assessment software of FIG. 1;

FIG. 3 is another embodiment of the New Assessment window shown in FIG. 2;

FIG. 4 is one embodiment of a Modify Assessment window generated by the test management and assessment software of FIG. 1;

FIG. 5 is one embodiment of a Verify and Edit Item Responses window generated by the test management and assessment software of FIG. 1;

FIG. 6 is an embodiment of a Create Report window generated by the test management and assessment software of FIG. 1;

FIG. 7 is one embodiment of a Classroom Response Roster report generated by the test management and assessment software of FIG. 1;

FIG. 8 is one embodiment of a Classroom Summary report generated by the test management and assessment software of FIG. 1;

FIG. 9 is one embodiment of an Individual Student report generated by the test management and assessment software of FIG. 1

FIG. 10 is one embodiment of an Individual Student Response report generated by the test management and assessment software of FIG. 1;

FIG. 11 is one embodiment of an Item Analysis report generated by the test management and assessment software of FIG. 1;

FIG. 12 is one embodiment of a Sub Test report generated by the test management and assessment software of FIG. 1;

FIG. 13 is one embodiment of a District Summary report generated by the test management and assessment software of FIG. 1; and

FIG. 14 is one embodiment of a Campus Summary report generated by the test management and assessment software of FIG. 1.

Corresponding reference numbers indicate corresponding parts throughout the several views of the drawings.

### DETAILED DESCRIPTION OF THE PREFERRED EMBODIMENTS

While the present invention will be described in the context of a school district, it can be appreciated that the present invention applies to any entity having an educational or training component which involves the testing of individuals. Moreover, the term “test” is meant to refer to any application which solicits information that needs to be assessed, such as a survey. In addition, the term document is meant to refer to any communication in any medium.

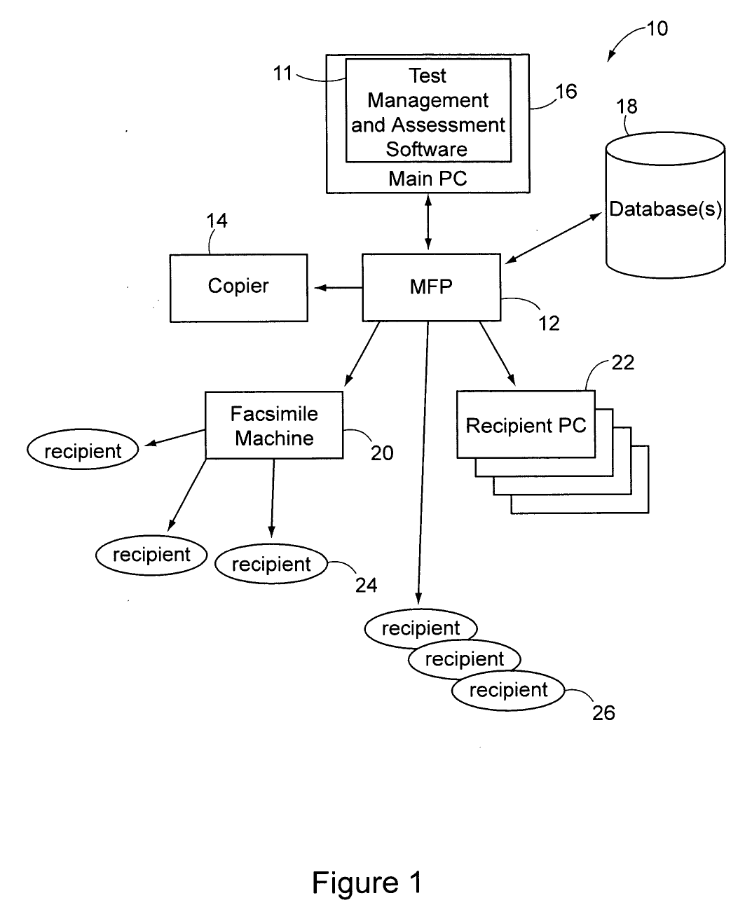

Referring to FIG. 1, the test management and assessment system 10 of the present invention generally includes a multi-function printer (MFP) 12, a copier 14, at least one personal computer (PC) 16 in communication with the MFP 12 and through which the test management and assessment software 11 of the present invention is accessible, and one or more databases 18. The various components of the system 10 are preferably networked (i.e., not necessarily all situated in the same physical location) such that the test management and assessment software 11 is accessible from the MFP 12, the copier 14, the PC 16 and/or any other device on the network. Documents can be distributed by email to recipient PCS 22, by facsimile to recipients 24 and/or by mail or hand delivery to recipients 26. It can be appreciated by one skilled in the art that recipients PCS 22 and fax recipients 24 may be on a different network than that of the school district.

The MFP 12 provides the functions of copying, printing, and scanning documents, including combined functions such as scanning and electronically mailing scanned documents. In one embodiment, MFP 12 is an enhanced RISO MFP with touch screen ability. The copier 14 is preferably a high-speed, multi-functional digital printing system that includes the functions of copying, printing, and scanning documents. If the expected run-lengths are too long for an MFP, the copier 14 may comprise a link enabled Riso, Inc. RZ390 printer duplicator. The database 18 stores the test data managed and assessed by system 10. The database 18 can be created and stored on PC 16, or PC 16 can be scripted to read from and write to one or more databases on the network. The latter configuration is preferred to prevent the need to manage multiple copies of the same data. The network may also be set up to include a client PC that interacts with a primary PC and in turn the database. Providing the client PC adds functionality to the system, allowing teachers to access stored tests, create new tests and access reporting functions. The system 10 may include a “client based” software that allows access from multiple networks. System 10 may also include a facsimile machine 20 to the extent that distribution of a document must be by facsimile. While facsimile machine 20 is shown in FIG. 1 as a separate device, it can be appreciated that it could be incorporated in the MFP 12, copier 14 and/or PC 16. In one embodiment, the minimum hardware requirements include a single location 2.4 GHz or higher server with 512 MB of RAM and a 20 GB hard drive, and the operating system is preferably Microsoft Windows 2000 SP4, Windows XP or Windows 2503 SPI.

On the software side, the test management and assessment system 10 generally includes document distribution software and the test management and assessment software of the present invention. For instance, the document distribution software may comprise Lexmark International, Inc.'s Document Distributor software. The document distribution software automates the process of distributing documents by capturing the paper and digital documents, converting the information therein to the appropriate format, and distributing the converted information to the appropriate destinations. The document distribution software can be accessed via the touch panel of the MFP 12, which can either prompt the user for information or allow the user to select a pre-configured option. The test management and assessment system preferably includes software such as Microsoft Word, Excel, Access, or software similar in functionality, which interacts with the test management and assessment software.

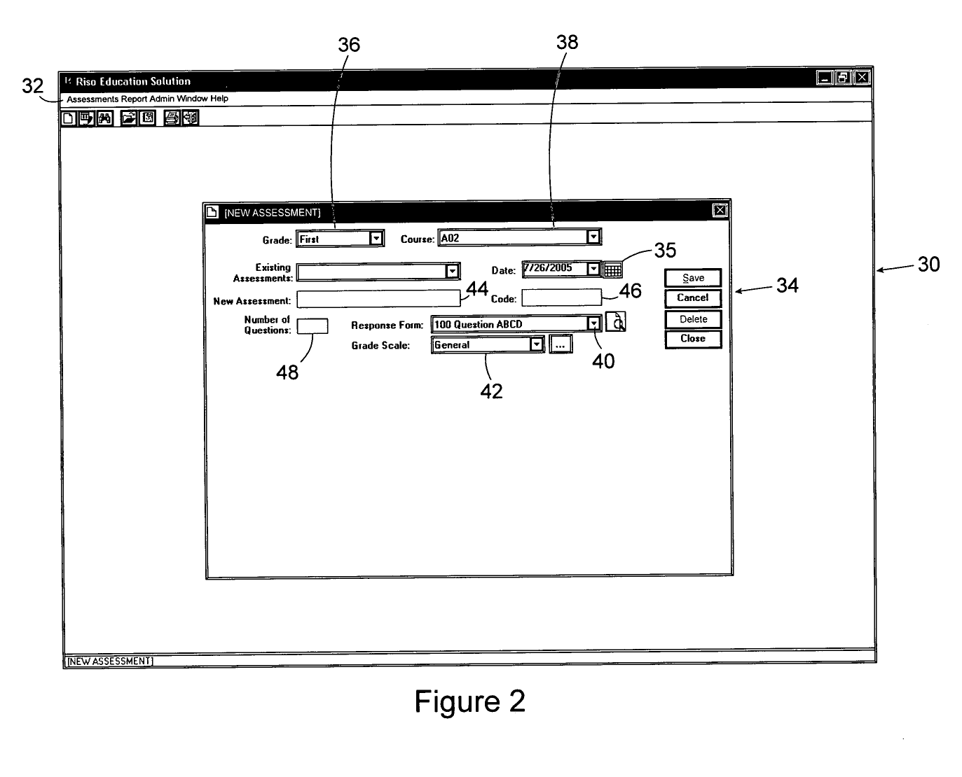

Once a user logs in to PC 16 and gains access to the test management and assessment software, a screen display such as screen display 30 shown in FIG. 2 is displayed. From this screen, all of the functions of the test management and assessment software can be accessed, including without limitation assessments, reports, administration and help functions. Assessment functions can be accessed via the Assessments button on the tool bar 32 of screen display 30. Once the Assessment button is selected, the available assessment functions are displayed, preferably from a drop-down menu (not shown). Such testing functions may include, without limitation, creating a new assessment, modify an existing assessment, printing a response form and validating assessment data.

In the case where a new test is being created, a window 34 having a plurality of input fields is displayed from which the user can select a date of creation 35, a grade 36 for which he or she would like to create a test (e.g., first grade, second grade, etc.), a course 38 for which the test is being administered, and a response form 40 and a grade scale 42 to be used. Preferably, the grade scale may be modified by the user during test creation. In one embodiment, the grade scale may be arranged to allow the teacher the flexibility to decide whether to use a point score or a letter grade, and/or provide the ability to correlate a point score to a letter grade. The user also inputs test information such as the test name 44 and preferably a code 46 or short name for the test, as well as the number of questions 48. In a preferred embodiment, several of the input fields include drop down menus from which predefined selections can be made (e.g., grade, course, response form and grade scale).

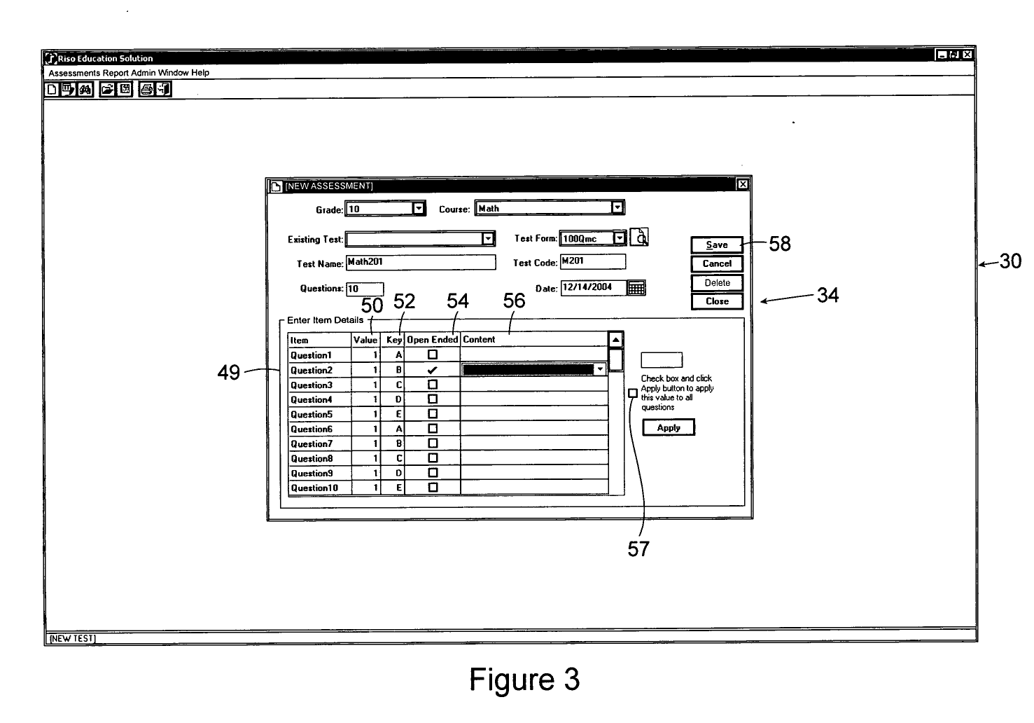

As shown in FIG. 3, once the number of questions is filled in, an Enter Item Details box 49 is automatically displayed in which the user can define a plurality of details for each question, including without limitation, a value 50 and an answer 53. With respect to the value, window 34 preferably includes a box 57 which a user can check and an Apply button 59 that the user can click to apply a particular value to all of the questions. The user may also define whether or not a question is open ended in the Open Ended field 54. The Enter Item Details box 49 also preferably includes a Content field 56 in which the user can indicate the content or subject matter to which the question is directed. As will be discussed later, a student's performance can then be assessed by content. It can be appreciated that other and/or additional fields can be made available through the New Assessment window 34 depending on the particular test at issue. Once the user has input all of the necessary information, the test can then be saved by clicking on the “Save” button 58.

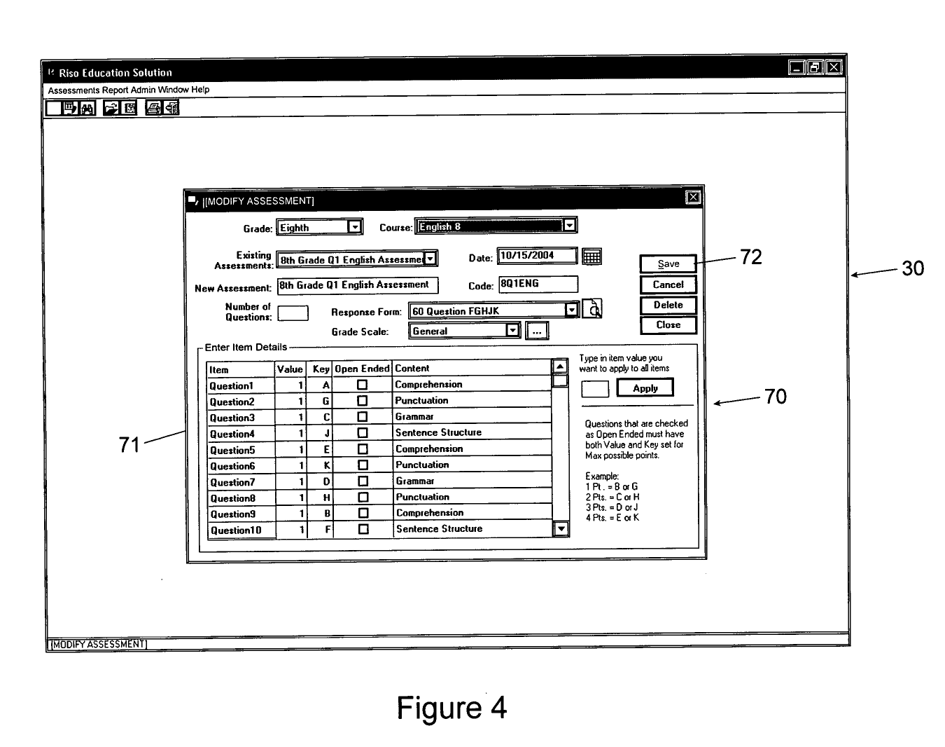

Existing tests can also be reviewed and/or edited from the Assessments menu of screen display 30. If selected, a Modify Assessment window 70 like that shown in FIG. 4 is displayed from which the user can enter the grade, course and test to be reviewed and/or edited. Once this information is input in, the remainder of the fields like those shown in FIG. 3 are automatically filled in and available for review and/or editing. Any edits can be made by clicking on the desired cell in the table 71 and then saved by clicking on the Save button 72. With such a configuration, test information can be set in real time, “on the fly,” and can also be easily changed. As a result, changes such as removing a question on a test can be easily accommodated.

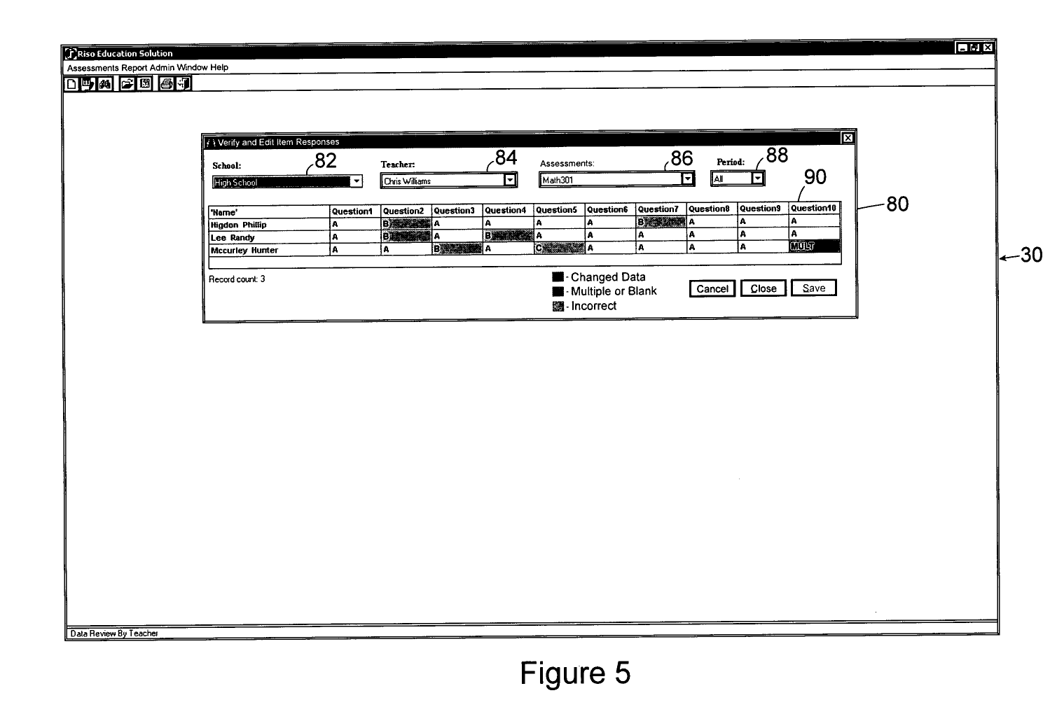

Once a test is created and administered, the bubble sheets containing data about each test, the test taker, and the test taker's answers can then be scanned, saved, reviewed, edited, and assessed as further described herein. The bubble sheet includes identifying information about the test and the test taker. For example, in the case of a test being administered at a school, such information may include coding to allow entry of the student's name and/or ID, the school name and/or ID, the grade name, the course name and the room and/or period name. Certain testing information may also will be automatically populated on the form. In one embodiment, the form may include a unique identifier or scan code associated with a particular assessment. Instead of separately inputting identifying codes such as course name and/or teacher name, the unique scan code may be inputted at the scanning station thereby saving time at the scanning station by reducing data input associated with the assessment. The scanned information can be reviewed and/or edited by selecting the “Verify and Edit Item Responses” option from the Test menu of screen display 30 (not shown). Preferably, the image of test taker's answer sheet can be viewed. Any changes to student answers may be tracked by an audit trail, for instance, color coding and/or via a user id and date/time stamp. Upon selection of this option, a Verify and Edit Item Responses window 80 like that shown in FIG. 5 is displayed. This window allows the user to select the school 82, teacher 84, assessment 86 and period 88 from the respective drop down menus. Once this information has been selected, data associated with the selected school, teacher, test and period, such as a list of students and their answers is then automatically displayed in a table 90. In a preferred embodiment, the cells in table 90 are color coded to highlight certain information, such as incorrect responses and multiple or blank responses.

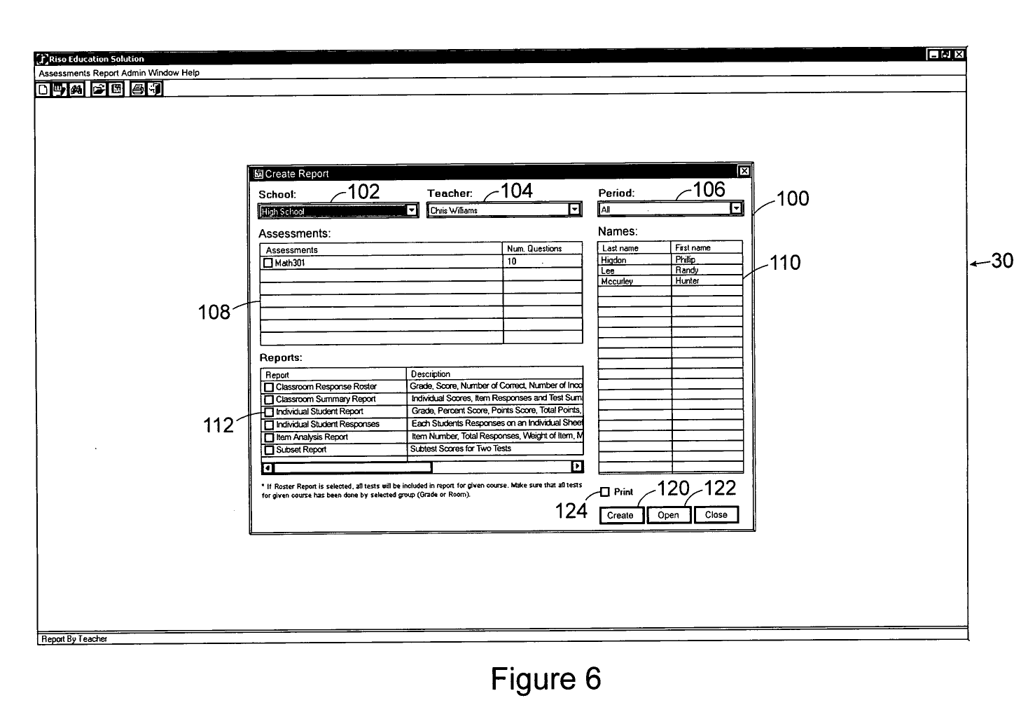

The test management and assessment software 11 also preferably provides statistical functionality for tabulating, analyzing and assessing the test data, and provides for the creation of reports reflecting such analysis. In a preferred embodiment, the test management and assessment software allows the user to selectively choose from a plurality of different types of assessments which can be displayed in a plurality of different reporting formats (e.g., chart, graph, etc.). Desired reports are preferably created by clicking on the Report menu from screen display 30. From there, a Create Report window 100 is opened from which the user can select the school 102, teacher 104 and period 106 for which he or she would like to generate a report. A report may be created by clicking on the Create button 120, viewed by clicking on the Open button 122, or printed by selecting the Print box 124 from window 100 as shown in FIG. 6. The assessment(s), students and available reports for the school/teacher/period combination selected will then be automatically displayed in the Assessments box 108, Students box 110 and Reports box 112, respectively. In the case where more than one test is displayed in the Assessments box 108, the user will need to select the test for which a report is desired.

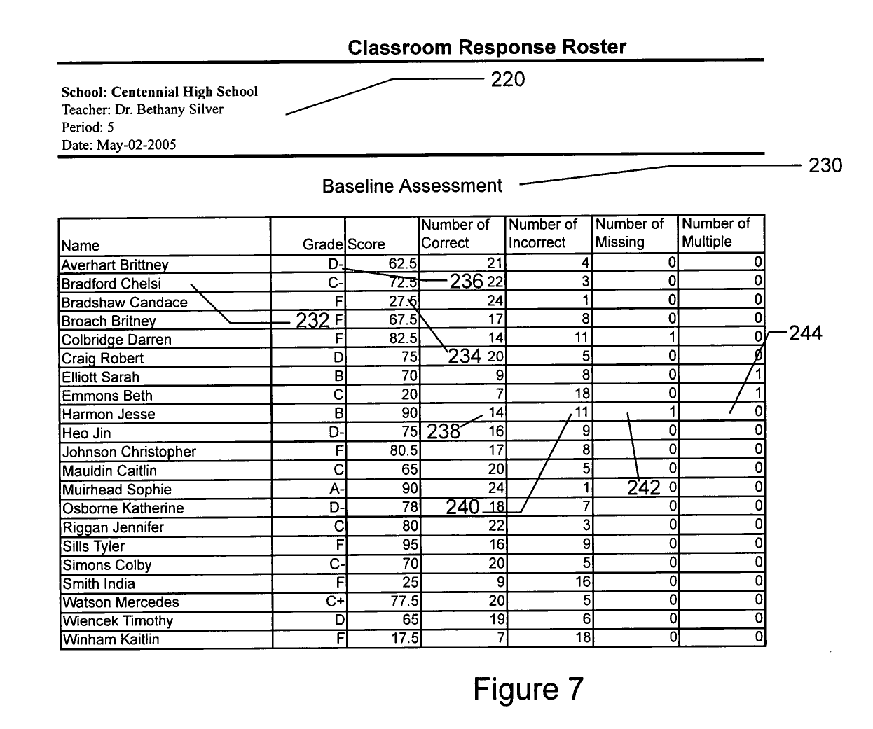

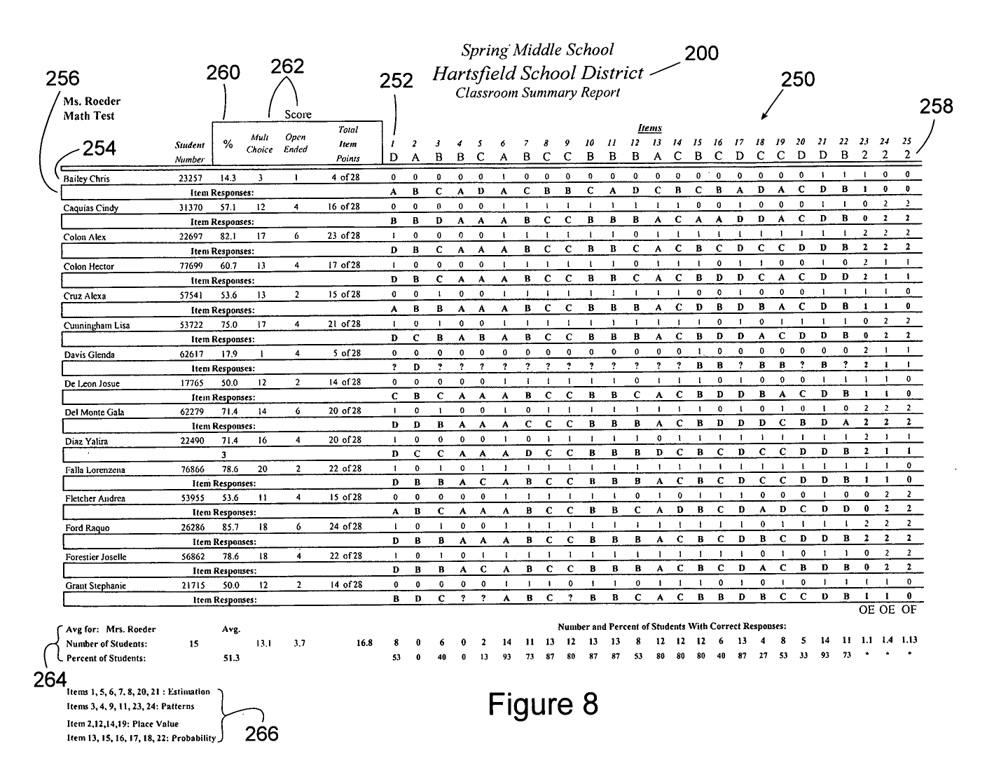

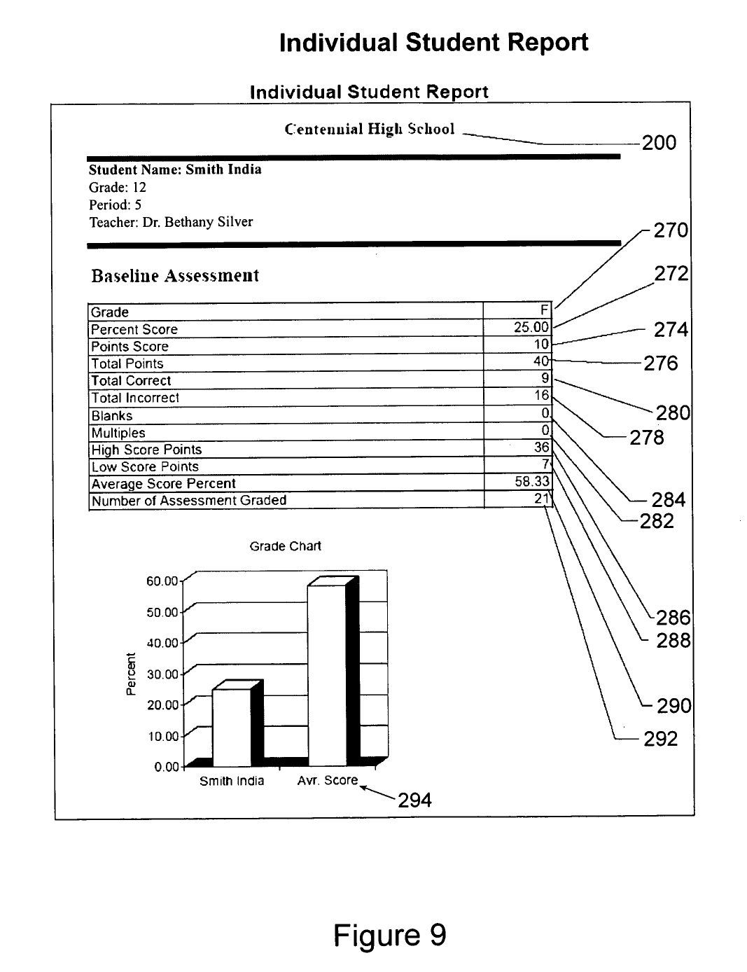

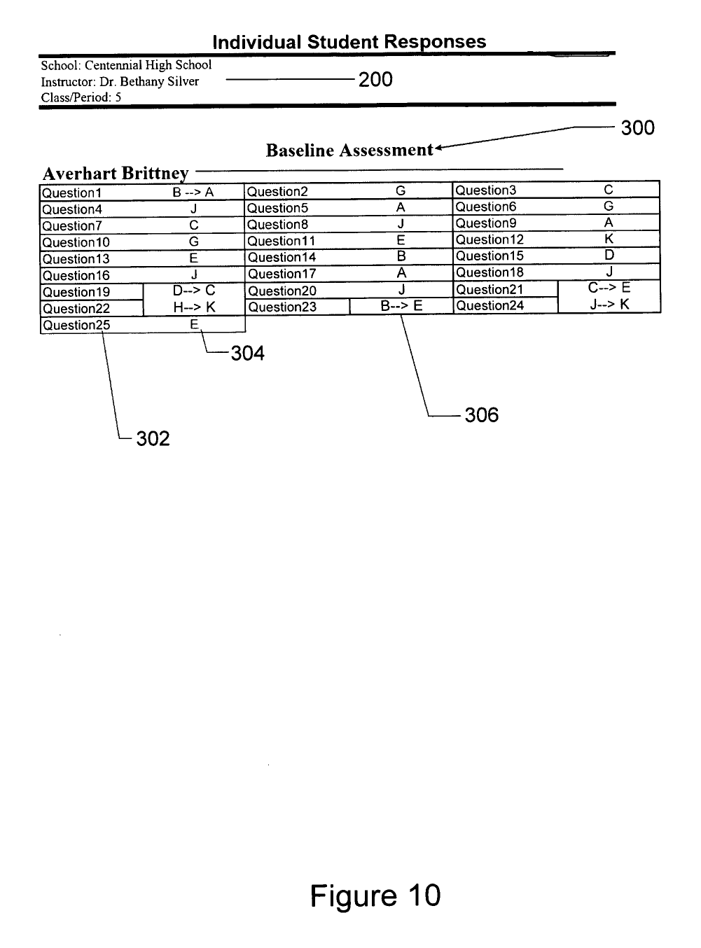

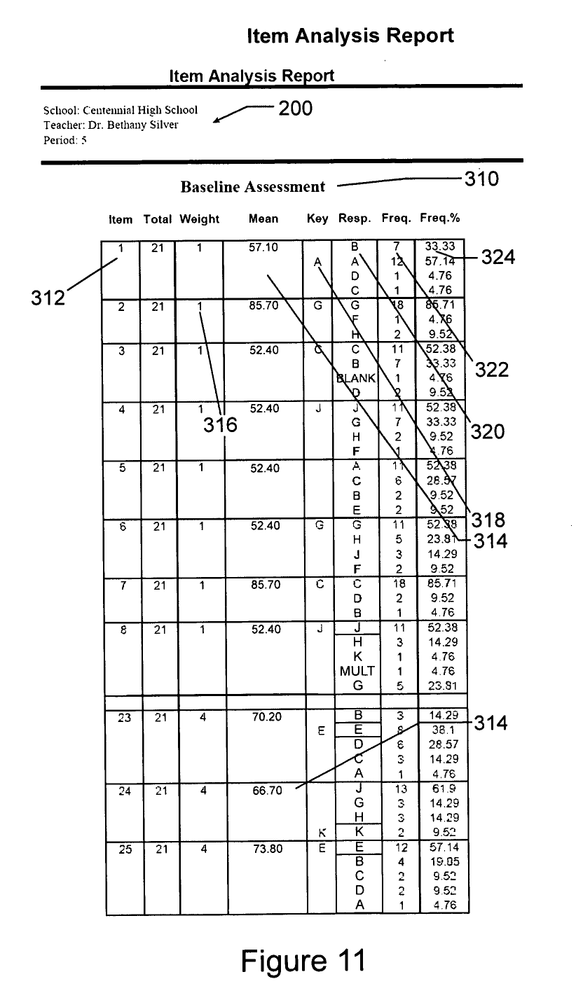

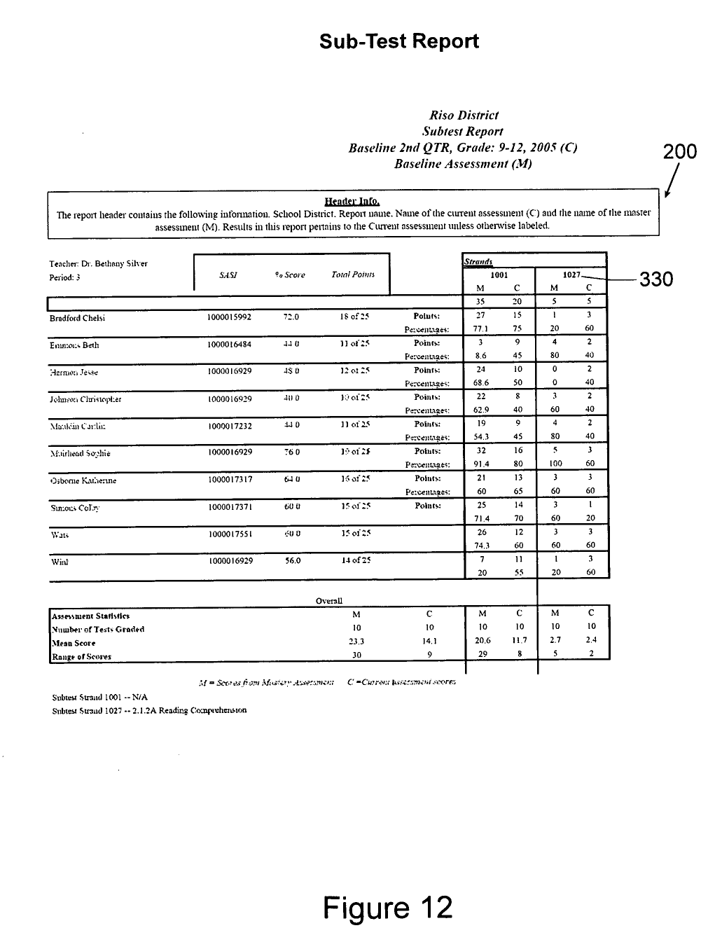

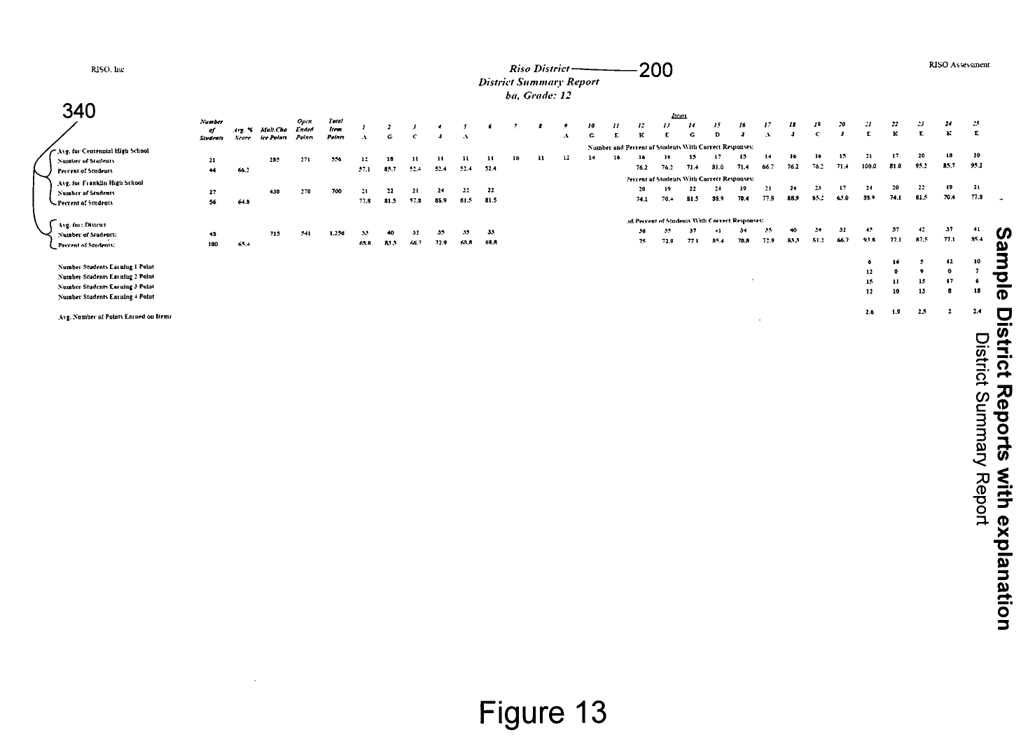

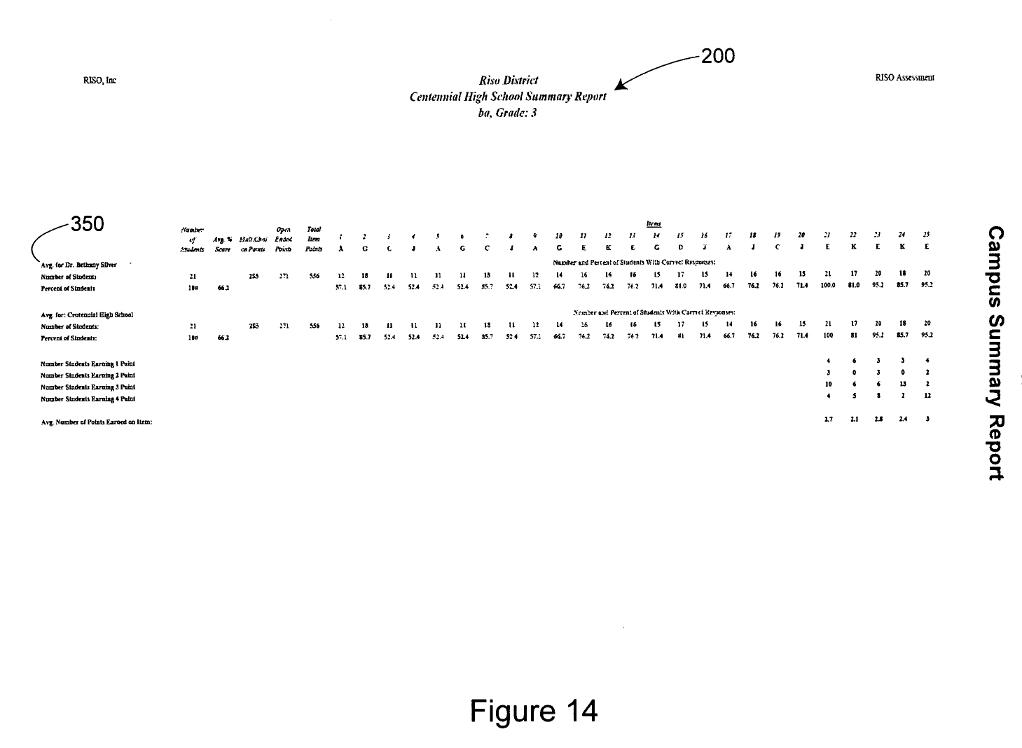

FIGS. 7-14 show preferred embodiments of report types that may be generated using the test management and assessment software and include, without limitation, a Classroom Response Roster report (FIG. 7), a Classroom Summary report (FIG. 8), an Individual Student report (FIG. 9), an Individual Student Response report (FIG. 10), an Item Analysis report (FIG. 11), a Subtest report (FIG. 12), a Sample District report (FIG. 13), and a Campus Report (FIG. 14). Preferably, each of the reports includes a header 200 with general identifying information about the report. For instance, the Classroom Response Roster report (FIG. 7), may contain identifying information regarding the school, the teacher, the period of the day when the assessment was administered as well as the date the report was created. Below the general identifying information, the report preferably comprises a chart containing specific information about the assessment. An explanation of the specific information contained in each of the aforementioned reports follows below.

Classroom Response Roster report (FIG. 7) comprises a chart 230 listing the test takers 232 and a percent score 234 achieved by the test taker on a particular assessment. The chart may also comprise additional columns correlating to the test taker that include a letter grade 236 representative of the percent score, the number of correct responses achieved by the test taker 238, the number of incorrect responses recorded 240, the number of responses recorded as blank or not answered by the test taker 242, and/or the number of responses answered by the test taker where more than one item was selected 244. With respect to these last two categories, the value is included in the number of incorrect responses recorded.

Classroom Summary report (FIG. 8) comprises a chart 250 with columns 252 that correspond to questions on a particular assessment and rows 254 that correspond to the number of points awarded to each test taker for his or her response to that specific question. The chart may also include a second row 256 that correlates to the test taker's answer to a specific question. The chart may also include a row 258 that indicates the correct answer for each question. In FIG. 8, a horizontal axis extends across the top of the chart and indicates the question number and the correct answer for the respective question. The chart may also include columns that indicate the test taker's percent score 260, and/or the number of correct responses achieved by the test taker 262. The report may also contain summary statistical information 264 at the bottom of the chart, including the classroom average percent grade received on the assessment, the average number of correct responses, the number of test takers who received a grade for the selected assessment, and the number of correct responses per question. The report may also include statistics 266 relating to performance on subcategories of subject matter.

The Individual Student report (FIG. 9) provides specific information on an individual test taker's performance on a specific assessment. This information may include, for example, the letter grade 270 that the student achieved, the percent score the student achieved 272, the number of points awarded to the test taker 274, the number of points available on a particular assessment 276, the number of incorrect responses 278, the number of questions with correct responses 280, the number of questions recorded as multiple responses 282, and/or the number of responses recorded as blank 284. The report also contains other information regarding the overall performance of the class, including the highest and lowest number of points awarded in the class 286,288, the average percent score achieved in the class 290, and the total number of assessments recorded as scanned data 292. The report may also contain graphical information 294 showing the individual student's performance relative to the overall class performance. As shown in FIG. 9, a bar graph provides a visual representation of this data.

The Individual Student Response report (FIG. 10) may be used to provide information to an individual test taker to assist him or her in evaluating their performance on a particular assessment on a question by question basis. Preferably, the report comprises a chart 300 showing each question number 302 on the assessment and the test taker's response 304 to the respective question. Preferably, the chart includes color coding to enable a report reviewer to quickly distinguish correct responses from incorrect responses. Preferably, when the test taker incorrectly answered a question, the chart includes a reference 306 indicating both the test taker's incorrect response along with the correct answer.

The Item analysis report (FIG. 11) is intended to provide a teacher with a tool to assist in evaluating the composite performance of all test takers on a specific question in a particular assessment. The report comprises a chart 310 listing the question 312 and average percentage 314 achieved by the test takers that participated in the assessment. The chart may include additional information pertaining to the specific question such as the number of points awarded for a correct response to the question 316, the answer for the question 318, all responses that have been selected for that question 320, the number of times 322 and/or the percentage of time 324 a particular response was selected.

The Subtest report (FIG. 12) provides information relating to the test taker's performance on certain parts of a particular assessment along with a comparison of the test taker's performance on a current assessment with a mastery assessment. By way of example, and not in any limiting sense, a mastery assessment may include a baseline assessment given at the beginning of a semester, a district wide or statewide standardized test or a personal goal for the test taker. In this way, the Subtest report is intended to be used to indicate a test-taker' progress through a comparison of performance on a current assessment with the baseline or mastery assessment. For instance, FIG. 12 shows the test taker's scores on the current and mastery assessments relating to the sub category 330 of reading comprehension. This allows the teacher and the test taker to evaluate the test taker's relative improvement as measured by the current assessment against the mastery assessment, including overall performance and performance on certain categories.

FIGS. 13 and 14 are similar in that they provide for global comparisons of test takers' performance on a district wide, teacher or class level basis, as desired. FIG. 13 provides information relative to a District's performance on an assessment by listing the aggregate scores of the test takers for a particular school in each row 340. FIG. 14 provides similar information, but provides aggregate scores based upon teachers or classes within a single school 350.

It should be appreciated, however, that any type of report can be made available by the test management and assessment software. Any of these reports can be created by clicking on the Create button 120, viewed by clicking on the Open button 122, or printed by selecting the Print box 124 from window 100 as shown in FIG. 6. Existing reports that have already been created can also be accessed via the Report menu on toolbar 32 of screen display 30 by selecting the Open Existing Report option, from which the user can then navigate to the directory where the report was saved. The reports are preferably saved in a Microsoft Excel spreadsheet so that the information can be easily manipulated, imported and exported. In a preferred embodiment, the test management and assessment software also includes a report wizard accessible through the Report menu through which a user is prompted with various questions to assist them in creating the desired report. Once created, reports can then be saved, exported and/or printed. In a preferred embodiment, the test management and assessment software also provides for the automatic translation of reports into a plurality of different languages. With such report capabilities, the user can benchmark test performance (e.g., by class, grade, teacher, demographics, etc.), as well as gauge a student's mastery of a given topic. The software also allows the user to import individual state standards or content areas to assist in benchmarking test performance.

In operation in a school environment, when a teacher wants to administer a test, he or she goes to the MFP 12, selects the desired test form from the touch panel and then prints the desired number of tests on the copier 14. If the test form is not on the system, the teacher can create a test as previously described herein. After the test is administered, the completed tests and an answer key are scanned into the MFP 12 and in a matter of minutes, the test management and assessment software automatically generates the results and an assessment thereof. Teachers and students thus gain valuable information in a record amount of time. This information is particularly valuable to the teacher, who can now review the missed questions to improve the students' understanding.

While the present invention has been described by reference to specific embodiments and specific uses, it should be understood that other configurations and arrangements could be constructed, and different uses could be made, without departing from the scope of the invention as set forth in the following claims.

We claim:

1. A test management and assessment system which uses an answer sheet having a plurality of test data fields, the test data fields including answer fields in which a test taker can input answers, comprising:
a device having a user interface defining a plurality of input fields and configured to receive input from a user from which a test for the answer sheet is created, the input fields including a plurality of question fields in which a corresponding plurality of questions can be input, a corresponding plurality of answer key fields in which a plurality of correct answers for each of the plurality of questions can be input, and a corresponding plurality of question value fields in which a plurality of question values can be selectively assigned to each question;
scanning means for scanning answer sheets upon their completion; and
assessment means accessible from the computer for automatically grading the answer sheets as they are scanned based on the correct answers and the question values.

2. The system of claim 1, further comprising storage means for storing a test created via the user interface, and wherein the user interface is further configured to allow a user to selectively edit the input associated with a stored test.

3. The system of claim 1, wherein the input fields further comprise a plurality of content fields in which a plurality of types of content may be assigned to each question, and wherein the assessment means comprises means for assessing the scanned answers for each answer sheet by content.

4. The system of claim 1, wherein the test data fields include a test taker field in which the name of a test taker may be input, and wherein the assessment means comprises means for assessing the scanned answers by test taker.

5. The system of claim 1, wherein the test data fields include a class name input field in which the name of the class for which the test is being administered may be input, and wherein the assessment means comprises means for assessing the scanned answers by class.

6. The system of claim 1, wherein the test data fields include a teacher input field in which the name of the teacher for which the test is being administered may be input, and wherein the assessment means comprises means for assessing the scanned answers by teacher.

7. The system of claim 1, wherein the assessment means further comprises means for creating a plurality of reports from which the test data can be assessed.

8. The system of claim 7, wherein at least one of the plurality of created reports comprises statistics relating to a test-taker's individual performance on the test and statistics relating to an overall performance of all test-takers taking the test.

9. The system of claim 8, wherein the created report comprises a test-taker's responses to each question on the test.

10. The system of claim 8, wherein said created report comprises categories of questions based upon distinct subject matter areas and statistics relating to a test taker's individual performance on the distinct subject matter area questions.

11. The system of claim 1, wherein a test data field comprises a machine readable code uniquely assigned to the test which when scanned automatically populates at least a portion of the test data fields of the answer sheet, identifies the test and reduces manual data input associated with the test during scanning.

12. A method of test management and assessment wherein each test uses an answer sheet having a plurality of test data fields, the test data fields including answer fields in which a test taker can input answers, comprising:
providing a user interface defining a plurality of input fields and configured to receive input from a user from which a test for the answer sheet is created, the input fields including a plurality of question fields in which a corresponding plurality of questions can be input, a corresponding plurality of answer key fields in which a plurality of correct answers for each of the plurality of questions can be input, and a corresponding plurality of question value fields in which a plurality of question values can be selectively assigned to each question;
scanning the answer sheets upon their completion; and
automatically grading the answer sheets as they are scanned based on the correct answers and the question values.

13. The method of claim 12, further comprising storing a test created via the user interface, and wherein the user interface is further configured to allow a user to selectively edit the input associated with a stored test.

14. The method of claim 13, wherein the input fields further comprise a plurality of content fields in which a plurality of types of content may be assigned to each question, and wherein the method further comprises the step of assessing the scanned answers for each answer sheet by content.

15. The method of claim 12, wherein the test data fields include a test taker field in which the name of a test taker may be input, and wherein the method further comprises the step of assessing the scanned answers by test taker.

16. The method of claim 12, wherein the test data fields include a class name input field in which the name of the class for which the test is being administered may be input, and wherein the method further comprises assessing the scanned answers by class.

17. The method of claim 12, wherein the test data fields include a teacher input field in which the name of the teacher for which the test is being administered may be input, and wherein the method further comprises the step of assessing the scanned answers by teacher.

18. The method of claim 12, further comprising creating a plurality of reports from which the test data can be assessed.

19. The method of claim 18, further comprising displaying on at least one of the plurality of created reports statistics relating to a test-taker's individual performance on the test and statistics relating to an overall performance of all test-takers taking the test.

20. The method of claim 19, further comprising displaying a test-taker's responses to each question on the test.

21. The method of claim 19, further comprising categorizing questions on the test into distinct subject matter areas, and displaying statistics relating to a test taker's individual performance on the distinct subject matter area questions.

22. The method of claim 12, further comprising assigning a unique, machine readable identifier to the test which when scanned automatically populates a least a portion of the test data fields of the answer sheet.
